(19) United States
(12) Patent Application Publication
(10) Pub. No.: US 2015/0342378 A1
(43) Pub. Date: Dec. 3, 2015

(54) NOTEBOOK COVER WITH INTEGRAL INFLATABLE PILLOW

(71) Applicant: Robert L. Boice, JR., Cartersville, GA (US)

(72) Inventor: Robert L. Boice, JR., Cartersville, GA (US)

(21) Appl. No.: 14/723,921

(22) Filed: May 28, 2015

Related U.S. Application Data
(60) Provisional application No. 62/003,894, filed on May 28, 2014.

(51) Int. Cl. A47G 9/10; A45C 11/00; B42D 3/12

(52) U.S. Cl. CPC A47G 9/1045; A47G 9/1027; B42D 3/12; A45C 11/00; A45C 2011/003

(57) ABSTRACT

A system providing of an inflatable pillow in conjunction with a planar substrate such as a book, a notebook, or a computing device. A cover member is adapted to be resiliently retained on the outer surface of the substrate. Entrained between the cover member and the substrate on one side of the substrate is a selectively inflatable air bladder. The air bladder can be integral to the respective substrate or fitted in or on a removable sleeve of the cover member. Selective inflatability enables the substrate-air bladder-cover system to be easily transported in an uninflated mode and to be a pleasant head rest in an inflated mode. The cover and air bladder may be adapted for being fitted to a user's existing substrate. Alternatively, the substrate, air bladder, and cover may be formed integrally and sold as a prefabricated unit. Further still, the air bladder may be replaceable with respect to a substrate—cover system, such that a user may select an air bladder that is most comfortable in terms of size when inflated and degree of firmness. Such a replaceable air bladder also enables repair or replacement in the case of a puncture or leak.

### STATEMENT REGARDING FEDERALLY SPONSORED RESEARCH OR DEVELOPMENT

N/A

### BACKGROUND OF THE INVENTION

It is not uncommon for educators to see a weary student with his or her head down, using a book as an ersatz and unsatisfactory pillow, sometimes during class. However, fatigue is not felt by students alone. Bus or train commuters, frequent flyers, authors, and athletes are some of the many types of people who may not have time to get sufficient sleep. This results in the all-too-common sight of someone fighting, unsuccessfully, to keep their head erect while attempting to take a fitful and fruitless nap.

Returning to the weary student, consider that if even a very brief but relaxed nap could be taken between classes, the student's ability to concentrate and participate could be greatly increased. “Nature has not intended mankind to work from eight in the morning until midnight without that refreshment of blessed oblivion which, even if it only lasts twenty minutes, is sufficient to renew all the vital forces.” (Winston Churchill). Churchill, Ronald Reagan, John F. Kennedy, Salvador Dali, and Thomas Edison are just a few examples of people who appreciated napping for its restorative powers. Yet, a rigid surface provides woefully inadequate comfort and frustrates the endeavors of even the most accomplished napper.

### BRIEF SUMMARY OF THE INVENTION

The presently disclosed invention pertains to an arrangement that provides the previously missing element of comfort for brief rests when only a planar substrate such as a notebook is available as a pillow. The present concepts relate to the provision of an inflatable pillow in conjunction with a planar substrate such as a book, a notebook, a computing device, etc. The pillow structure can be integral to the respective substrate or fitted in or on a removable sleeve or cover.

Inflatability enables the substrate-air bladder-cover system to be easily transported. For example, a three-ring binder notebook with an inflatable pillow cover can be packed in a backpack once the air bladder is deflated. Likewise, a notebook or laptop computer having a pillow cover can be conveniently packed in carry-on luggage once the air bladder is deflated. Once aboard an airplane and with permission to remove carry-on objects, the user can lower their tray table, place the notebook or laptop computer on the tray table, inflate the pillow, and comfortably rest without the need to rest their head on top of crossed arms atop the tray table, to lean against the vibrating and cold aircraft bulkhead, or to lean against a warm but awkward stranger's shoulder.

Embodiments include use of a variety of fabrics and materials for enclosing the air bladder, as well as for the air bladder itself. Different materials may be used for the portion of the cover that is presented outwardly, to the user, as compared to the portion used to entrain the air bladder proximate the substrate. Further, the air bladder itself may be of a separate material. Considerations in choosing materials include presenting a pleasant surface upon which a user may rest their cheek, neck or forehead, resistance to staining, ease of cleaning or washing, water repellency, elasticity, inflatability, suitability for printing or dyeing, puncture or tear resistance, and resistance to odor entrapment.

Embodiments also include a cover and air bladder suitable for being fitted to a user's existing substrate, such as a three-ring binder notebook or laptop computer. Alternatively, the substrate, air bladder, and cover may be formed integrally and sold as a prefabricated unit. Further still, the air bladder may be replaceable with respect to a substrate—cover system, such that a user may select an air bladder that is most comfortable in terms of size when inflated and degree of firmness. Such a replaceable air bladder also enables repair or replacement in the case of a puncture or leak.

### BRIEF DESCRIPTION OF THE SEVERAL VIEWS OF THE DRAWINGS

Aspects of the described embodiments are more evident in the following description, when read in conjunction with the attached Figures.

FIG. 1 is a front-top perspective view of a cover according to the presently disclosed invention;

FIG. 2 is a top view of an air bladder according to the presently disclosed invention;

FIG. 3 is a top view of the cover of FIG. 1 and air bladder of FIG. 2 partially installed with respect to a substrate;

FIG. 4 is a top-front perspective view of a portion of the cover of FIG. 1 installed with respect to the substrate of FIG. 3;

FIG. 5 is a top view of a system comprising the cover of FIG. 1, entraining the air bladder of FIG. 2, installed upon the substrate of FIG. 3;

FIG. 6 is a top-front perspective view of the system of FIG. 5 with an optional frame and foldable legs;

FIG. 7 is a top-front perspective view of the system of FIG. 5 without the frame or legs;

FIG. 8 is a top view of a portion of the system of FIG. 5;

FIG. 9 is a first side view of the system of FIG. 5 in which the air bladder of FIG. 2 is inflated; and

FIG. 10 is a second side view of the system of FIG. 5 in which the air bladder of FIG. 2 is inflated.

### DETAILED DESCRIPTION OF THE INVENTION

In general, the presently disclosed and claimed invention includes a system comprising a substrate, an air bladder, and a cover entraining the air bladder with respect to the substrate. The substrate may be a notebook, such as a three-ring binder, a notebook or laptop computer, or other substantially planar object. While the most likely substrates are substantially rectangular, substrates of other shapes may also be employed. For example, a round object such as a FRISBEE brand flying disc toy may be employed in the present invention with a suitably shaped cover and air bladder.

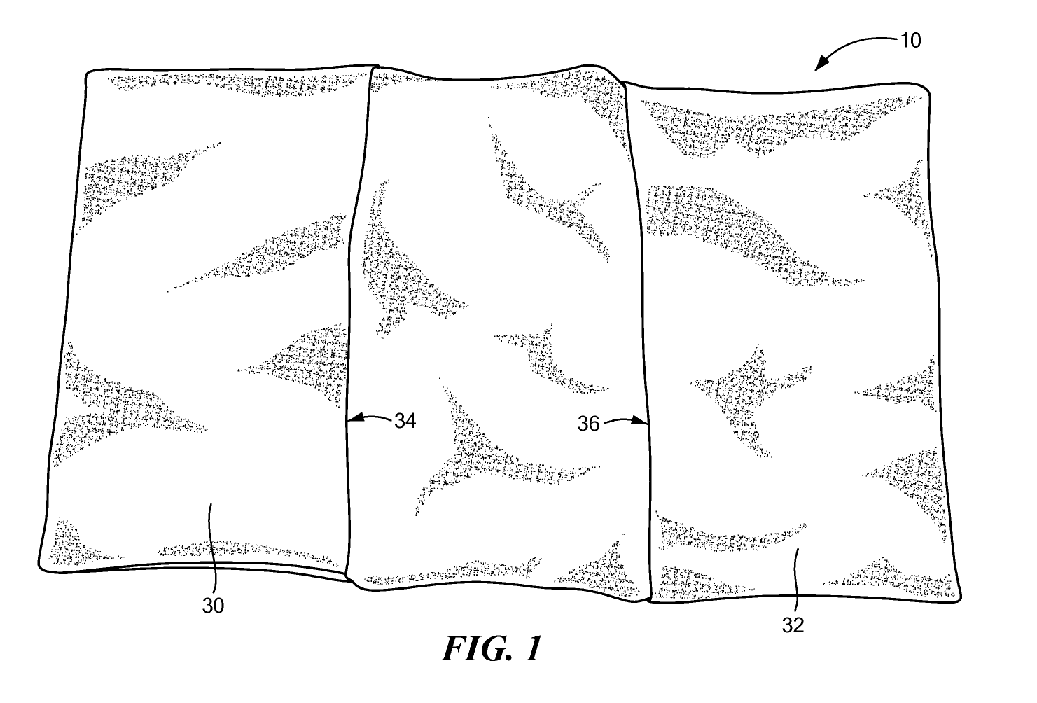

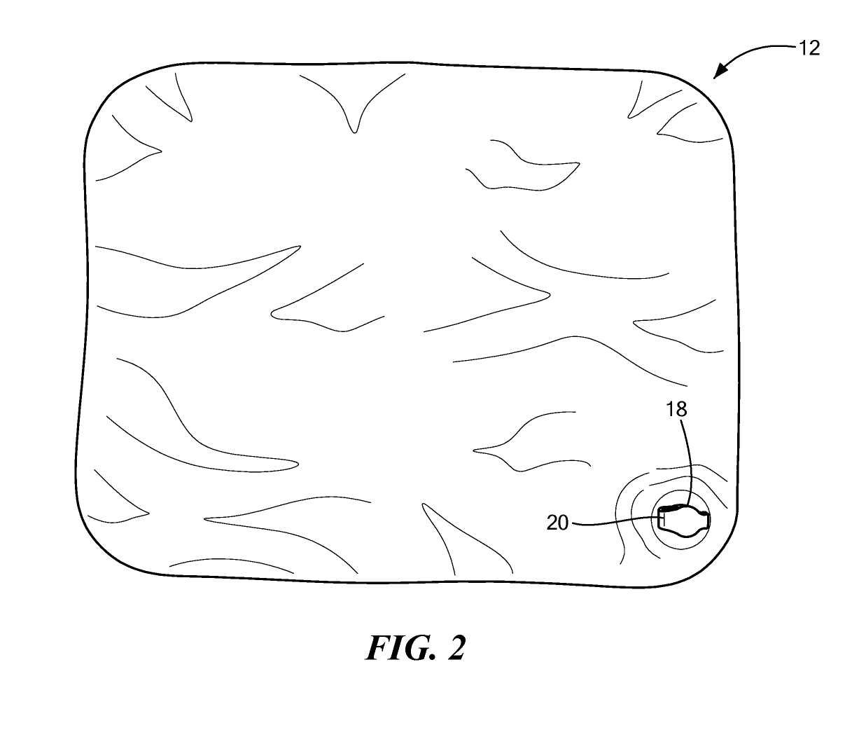

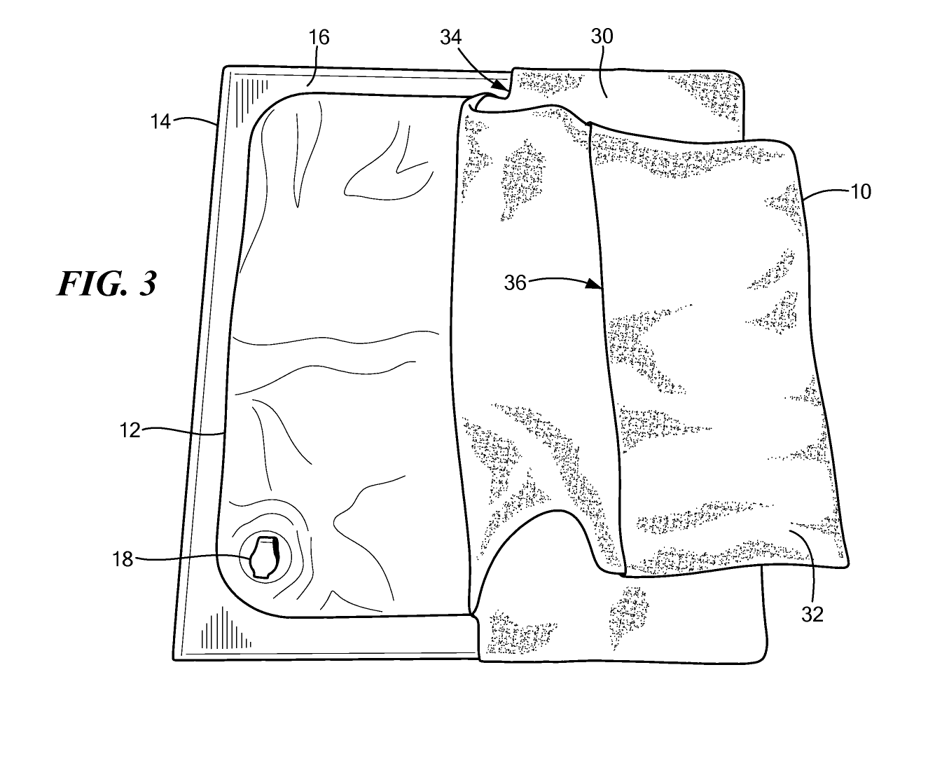

Embodiments of the present invention are varied. With respect to FIG. 1, one embodiment includes a stretchy, resilient fabric configured as a familiar notebook or textbook cover 10. An inflatable air bladder 12, such as shown in FIGS. 2 and 3, is configured to be disposed between one side of the notebook or textbook 14 panel 16 outer surface and the fabric cover 10. The panel, in the context of a notebook, is a hinged upper or lower cover of the notebook.

A member enabling selective inflation and deflation, otherwise referred to as an inflation member, such as an outwardly projecting plastic air valve 18, is provided in conjunction with the air bladder. Such a valve may be of the form of a stem with or without an internal air flap. Preferably, the stem valve is provided with a valve plug or cover retained to the valve body via a living hinge 20, such as commonly found in conjunction with children's inflatable balls, floats and toys. Such a stem valve may be invertable when the air bladder is inflated such that the valve does not project outwardly. In an embodiment in which the inflatable bladder is integrated into the substrate or in which the substrate is specifically configured to receive the inflatable bladder on a surface thereof, the substrate itself may have a hole or other discontinuity beneath the valve to enable the latter to be inserted fully into the substrate when not in use. Inflation results from a user blowing into the valve, and deflation results from digital deformation of the valve stem and displacement of an internal air flap, or more simply the removal of a valve cover member.

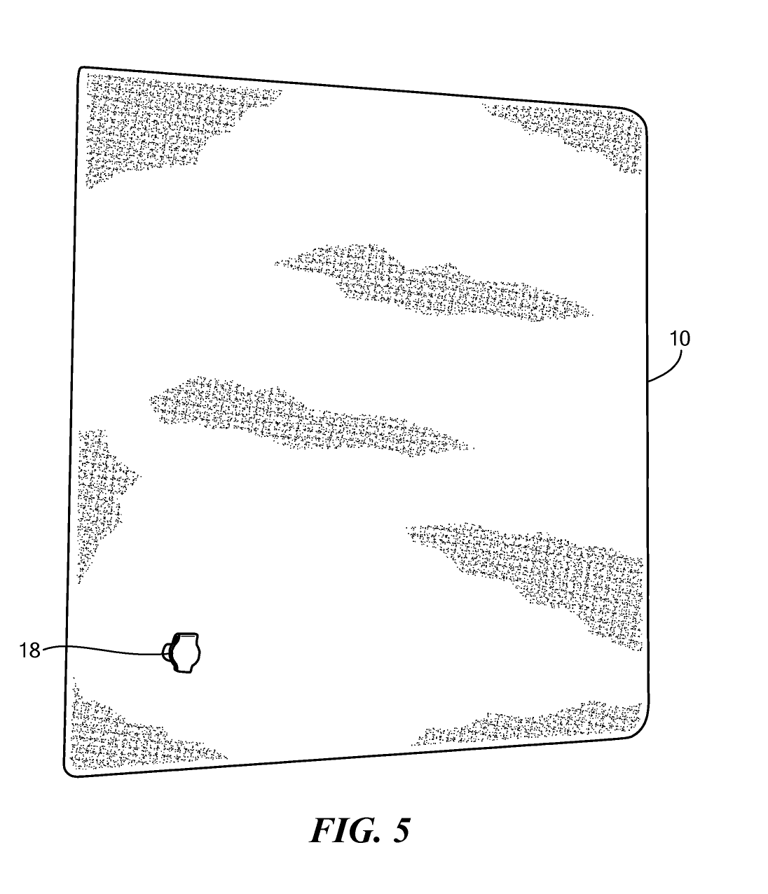

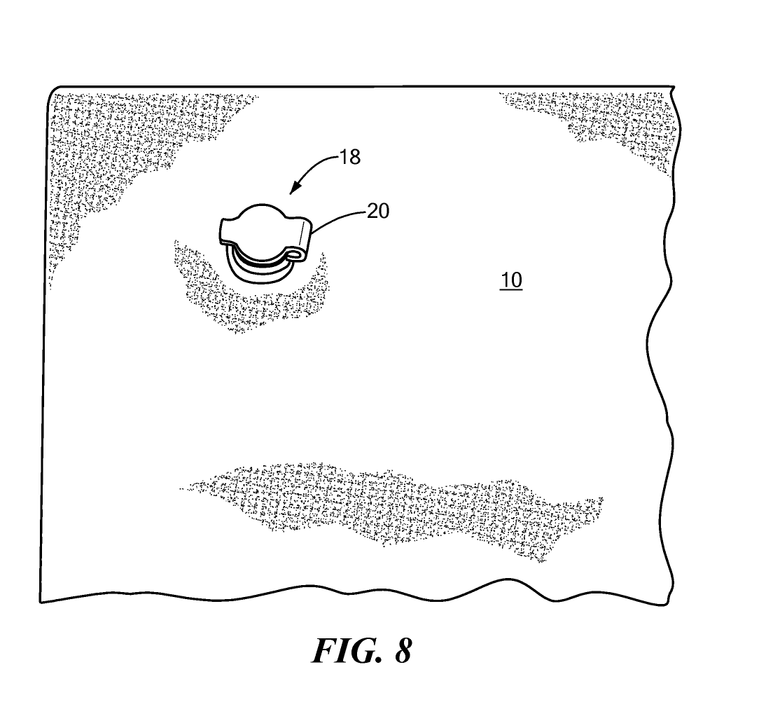

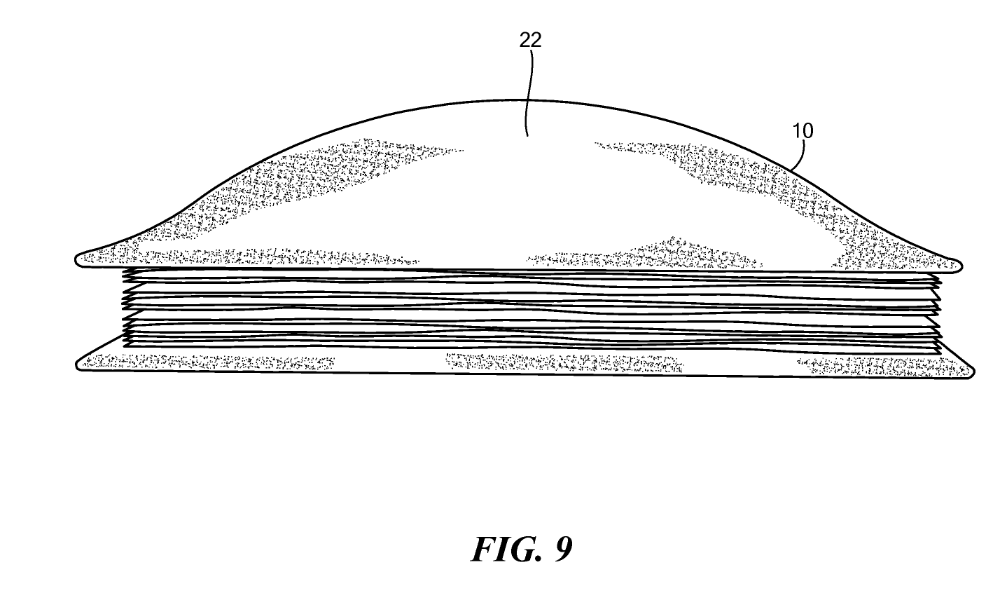

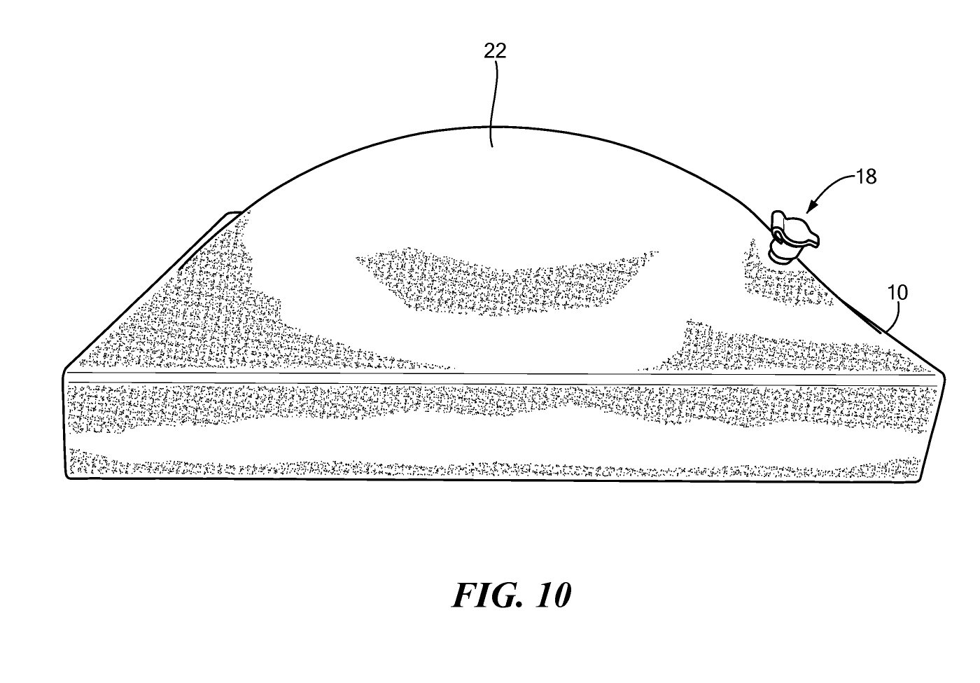

The valve 18 is preferably integral with the air bladder 12. Further, the valve may be integral with the cover 10 and/or may protrude therethrough, as shown in FIGS. 5-8, for easy operation by a user. The air bladder 12 itself may be selected from a variety of suitable materials chosen with consideration to stiffness, flame resistance, durability, and air impermeability. Exemplary materials for the air bladder and valve include thermoplastic polyurethane (TPU) and polyvinyl chloride (PVC). While many instances of a simple air bladder may be employed, the bladder preferably has a flat side to be positioned or positionable adjacent the substrate surface 16 and a contoured side (when inflated) projecting outward, thereby forming a projecting pillow surface 22, as shown in FIGS. 9 and 10. The specific contour of the air bladder and thus the pillow surface can be chosen to gradually increase away from the bladder edge to a peak near the center, when inflated. In other versions, not shown, a portion of reduced thickness may be provided in the center of the bladder or along a line transecting the bladder, when inflated, in order to resist the temptation for a user's cranium to roll off the pillow towards the edges during slumber.

Other suitable valve members, not shown, include those operable in connection with a mechanical source of compressed air such as a manual or electric bicycle or other air pump. Such a valve member would be physically configured to selectively and sealingly interface to the respective air source such as through a releasably engaging collar or a valve-penetrating protrusion.

The valve member may also be provided as a pump operable by a user depressing a resilient button with his or her finger (not shown). Such devices have been previously employed on select styles of sports footwear. Deflation is achieved by manually manipulating a pressure relief valve within the pump member. Other inflation members are employable such as an air bulb having a one-way valve for inflation and a discrete, manually actuable valve for deflation.

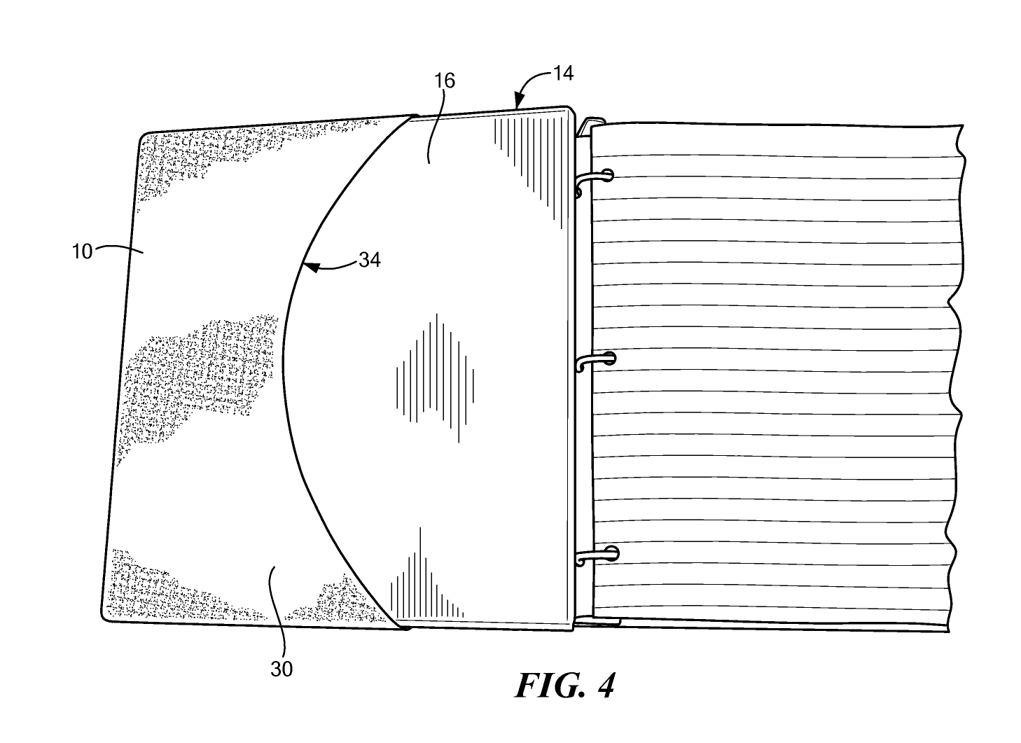

One class of product according to the present invention is configured for being retrofit to various substrates. As described, a three-ring binder or other similarly configured notebook 14 can be provided with an after-market resilient cover 10 with integral air bladder 12. A variety of fastening means may be provided. For instance, the cover material itself may have sufficient flexibility and resilience to enable it to stretch over opposing hinged panels of the notebook. As shown in FIG. 1, the cover 10 is provided with opposing sleeves 30, 32, each forming a respective pocket 34, 36 sized to receive a respective substrate panel 16. In FIG. 3, a panel 16 of the substrate 14 has been installed in one pocket 34 formed by a sleeve 30 of the cover 10, with the air bladder 12 disposed therebetween. In FIG. 4, the pocket 34, formed by the respective sleeve 30 of the cover 10, receives the uppermost hinged substrate panel 16.

Alternatively, the cover 10 may be provided with resilient members such as elastic straps (not shown) to accommodate a variety of substrate sizes and shapes. Further still, the cover may be provided with mechanical fastening means (not shown) for positively engaging, for example, the edges of a substrate cover 16. Adhesive means such as tape, glue, hook-and-loop fasteners, etc., can also be employed in keeping the cover in place with respect to the substrate.

In alternative embodiments, the air bladder 12 is permanently affixed to or integral with the substrate 14, but the fabric cover 10 is removable. This facilitates the use of a variety of decorated covers, each of which may be provided with custom decorations such as flags, sports team insignia, etc. Plain covers may be provided for enabling a user to customize the cover according to his or her taste and style. It also enables the washing of covers.

In a further embodiment, both the cover 10 and inflatable bladder 12 are provided integral to the respective substrate.

The material used for the cover has been described as stretchy and resilient, such as spandex or elastane. However, other materials may be chosen for traits such as durability or comfort, including fleece, cotton, corduroy, ULTRASUEDE brand non-woven suede-like fabric, etc. The material overlaying the air bladder and providing the rest surface for the user upon inflation may be of one fabric type, whereas the remainder of the cover may be of a more durable, stain-resistant material. In particular, the portion of the cover on what is the lower substrate surface, when configured for use as a pillow system, is preferably provided as a scuff-resistant, durable material.

The substrate 14 may be a binder, such as a two-ring, three-ring, or other style binder (collectively, a “multi-ring binder”), as shown in FIG. 4. The substrate may be a book, such as a textbook or reference text, or a clipboard with or without an integral cover. Further, the substrate may be an electronic device such as a laptop computer, a notebook computer, a tablet-style device, etc. In the latter embodiments, the cover is preferably provided with apertures sized and placed to enable the free flow of air and venting of heat from the device chassis and access to interfaces such as USB or HDMI ports, power ports, touch pads, etc.

In a further embodiment, folding members such as legs 40 are provided on the side of the substrate 14 opposite from the inflatable bladder 12. Such legs may be provided in hinged relationship with a rigid or semi-rigid frame 42 that is affixable to the substrate. Such an arrangement can be integrated with a bladder-retaining cover 10 that is affixed to the substrate. Alternatively, the frame can be affixed to a substrate with or without an integral bladder, with or without an integral cover. The frame may be attached to the substrate via mechanical fasteners including screws or other threaded members, resilient bands or elastics, hook-and-loop fasteners, glue, tape, etc. Such foldable legs enable the elevation of the inflatable pillow to an optimal height for temporary slumber. The legs may be hinged with respect to the frame in a variety of arrangements, as known to one skilled in the art.

In FIG. 4, the substrate 14 is a three-ring binder opened to show the respective interior portion. The uppermost hinged substrate panel 16 of FIG. 3 is shown opened along the left-hand hinge. The interior edge of the first sleeve 30 of the cover 10 is shown as a semi-circular curve. However, a variety of edge shapes can be employed. The cover interior portion, shown in FIG. 4, can also be optionally provided with various ancillary features, including pockets for business cards, paper money or credit cards, pen or pencil holders, eyeglass holders, telephone pockets, etc.

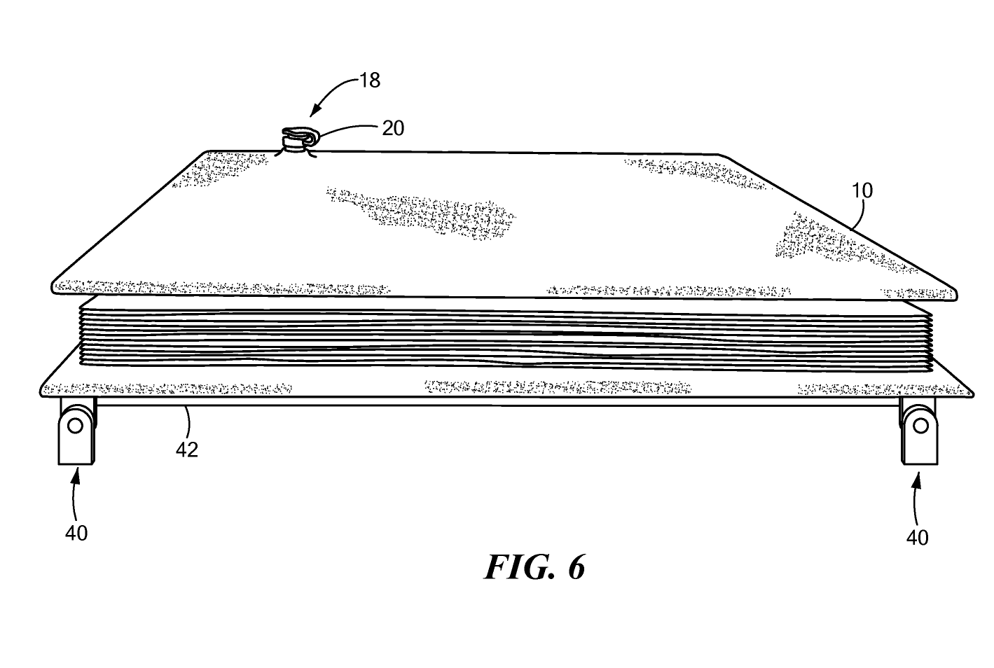

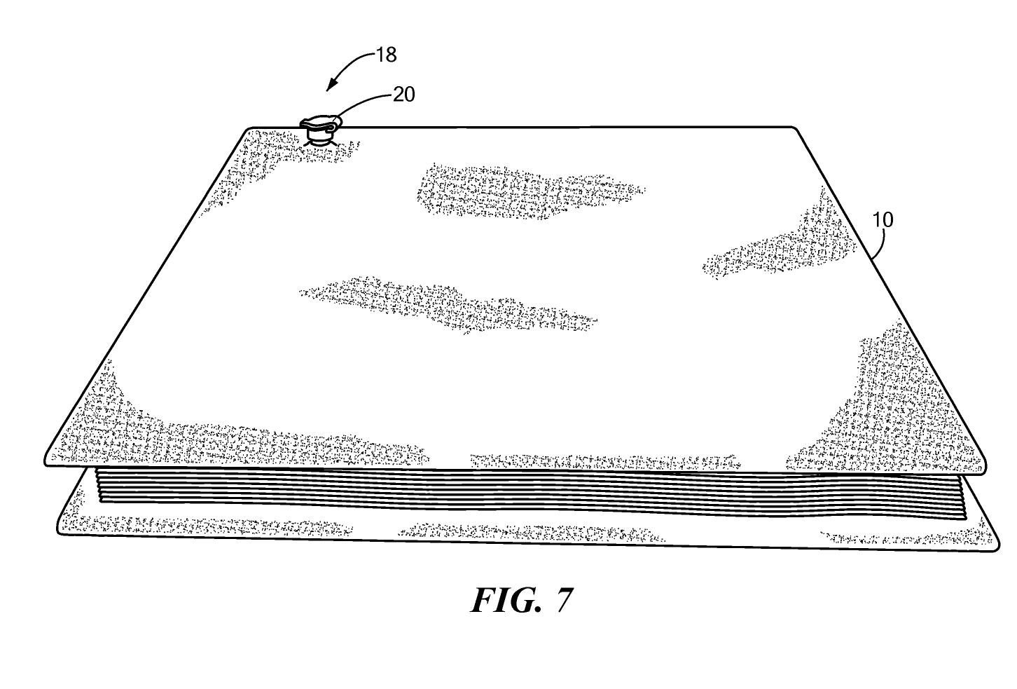

FIGS. 6 and 7 are low-angle views of the substrate with cover 10 of FIG. 5. It is apparent from these views that, when deflated, the air bladder and cover contribute very little to the overall thickness of the substrate-bladder-cover system.

In FIGS. 9 and 10, air or other gas has been introduced into the bladder entrained between the cover 10 and substrate, thus providing a comfortable, pliant surface 22 upon which the taxed user may rest its head.

In further embodiments, additional features may include a source of heat or cooling air, such as from a thermoelectric device (TED), to warm or cool the air within the bladder. Inflation of the bladder may also be achieved through the use of an integral, internal electric pump. The cover-bladder system may also be provided with a programmable alarm mechanism, such as a vibratory or annunciating member intended to rouse a user from restful slumber. Any of these additional features may be powered by internally carried batteries that are rechargeable and/or replaceable, solar power, or plug-in power.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A selectively inflatable pillow system, comprising:
a cover member at least partially comprised of a resilient fabric;
a selectively inflatable air bladder with an integral valve member; and
a substrate having at least one planar panel,
wherein the cover is dimensioned to be installed on an outer surface of the at least one panel of the substrate and to entrain the air bladder therebetween.

2. The system of claim 1, wherein the substrate is selected from the group consisting of: a notebook; a multi-ring binder; a notebook computer; and a laptop computer.

3. The system of claim 1, wherein the valve member comprises a stem with a valve plug or cover retained with respect to the stem by a living hinge.

4. The system of claim 3, wherein the at least one planar panel of the substrate has a discontinuity formed therein proximate the valve member when the cover member is installed on the outer surface of the substrate with the air bladder entrained therein, the discontinuity dimensioned to receive at least a portion of the stem when inverted with respect to the air bladder.

5. The system of claim 1, wherein the air bladder comprises, when inflated, a substantially flat surface and an opposite contoured surface, wherein the substantially flat surface is disposed adjacent the at least one planar panel of the substrate.

6. The system of claim 1, wherein the valve member comprises a manually actuable pump with a manually actuable pressure relief valve.

7. The system of claim 1, wherein the cover is comprised of opposing sleeves, each forming a respective pocket sized to receive a respective substrate planar panel.

8. The system of claim 1, wherein the air bladder is integrally formed with the at least one planar panel of the substrate, whereas the cover member is removable.

9. The system of claim 1, wherein the cover member is comprised of a first material type and a second material type, the first material type to be disposed at least over the air bladder when installed on the outer surface of the at least one planar panel of the substrate to entrain the air bladder therebetween, and the second material type to be disposed at least on a side of the substrate opposite the first material type.

10. The system of claim 1, wherein the substrate is an electronic device and wherein the cover member is provided with discontinuities to enable air circulation to and from the electronic device.

11. The system of claim 1, further comprising folding leg members disposable on the substrate on a planar panel opposite the at least one planar panel upon which the cover is dimensioned to be installed for entraining the air bladder therebetween.

12. The system of claim 11, further comprising a frame upon which the folding leg members project.

13. The system of claim 12, wherein the frame is provided integral to the cover member.

14. The system of claim 12, wherein the frame is removably mountable with respect to the cover member via mechanical fasteners.

15. The system of claim 1, further comprising a source of heat or cooling air for selectively heating or cooling the air within the air bladder.

16. The system of claim 1, further comprising a programmable alarm mechanism.

17. The system of claim 16, wherein the programmable alarm mechanism is selected from the group consisting of a vibratory alarm and an annunciating alarm.
